(19) United States
(12) Patent Application Publication
(10) Pub. No.: US 2009/0292407 A1
(43) Pub. Date: Nov. 26, 2009

(54) SOLAR-POWERED AIRCRAFT WITH ROTATING FLIGHT SURFACES

(75) Inventors: Robert J. Minelli, Burke, VA (US); Stephen Haase, Falls Church, VA (US); Richard Kutyn, Chantilly, VA (US)

Correspondence Address: ROPES & GRAY LLP, PATENT DOCKETING 39/41, ONE INTERNATIONAL PLACE, BOSTON, MA, 02110-2624, US

(73) Assignee: Orbital Sciences Corporation, Dulles, VA (US)

(21) Appl. No.: 12/471,094

(22) Filed: May 22, 2009

Related U.S. Application Data
(60) Provisional application No. 61/128,510, filed on May 22, 2008.
(60) Provisional application No. 61/130,148, filed on May 27, 2008.

(51) Int. Cl. B64D 27/24; G05D 1/00; H01M 8/02; H01M 8/18

(52) U.S. Cl. 701/3; 244/53 R; 429/13; 429/19

(57) ABSTRACT

A solar-powered aircraft having a rotating tail assembly and/or a fore assembly is provided. The tail and fore assemblies have solar cells mounted on their upper surfaces and are rotated during flight to track the sun.

### CROSS-REFERENCE TO RELATED APPLICATIONS

This claims the benefit of U.S. Provisional Application No. 61/128,510 filed May 22, 2008, entitled, “Aerial Vehicle with Sun Tracking Tail,” and U.S. Provisional Application No. 61/130,148 filed May 27, 2008, entitled, “Aerial Vehicle with Sun Tracking Tail,” the entirety of each of which is incorporated herein by reference.

### FIELD OF THE INVENTION

The invention relates to solar-powered aircraft. More particularly, the invention relates to solar-powered aircraft having solar arrays that track the sun.

### BACKGROUND OF THE INVENTION

Several efforts have been made in the past to develop solar-powered aircraft, including, for example, the HELIOS solar-powered aircraft developed by NASA. Such solar-powered aircraft typically generate power from solar cells affixed to the upper surfaces of the wings and tail. However, in these aircraft, the wings and tail are fixed in position. As a result, during large portions of the day, particularly in the fall and winter, they suffer from reduced sun exposure, or exposure to the sun at angles that are non-optimal for solar-cell power generation. This reduces the times of day and seasons during which they can carry out missions.

Another aircraft, the SOLITAIR, designed by DLR Institute of Flight Systems includes independent solar arrays coupled to twin fuselages. Such solar arrays substantially add to the weight of the aircraft, requiring more powerful motors and larger flight surfaces.

### SUMMARY OF THE INVENTION

To address the deficiencies of the prior art, the invention relates to a solar-powered aircraft that includes a solar-power generating tail and/or fore assembly that rotate about a longitudinal axis of the aircraft to track the sun.

According to one aspect, the invention relates to an aircraft that includes a fuselage, a wing assembly, at least one electric motor, a tail assembly, and a drive motor for rotating the tail assembly about a longitudinal axis of the aircraft. The drive motor rotates the tail assembly based on position of the sun relative to the aircraft. The fuselage has a front and a rear and defines the longitudinal axis about which the tail assembly is rotated. The wing assembly couples to the fuselage and includes flight control surfaces for maneuvering the aircraft.

The tail assembly includes at least two fins. Solar cells are mounted on the upper surfaces of the fins. The solar cells generate electricity to drive at least one electric motor that powers the aircraft. In one embodiment, the fins are configured in a shallow “v” configuration.

In another embodiment, the tail assembly includes a third fin. In such an embodiment, the angles between each of the at least two fins having solar cells mounted thereon and the third fin are equal and are greater than 90 degrees.

In one embodiment, the aircraft includes an energy store coupled to the solar cells and the electric motor. In one embodiment, the energy store is a rechargeable battery. In another embodiment, the energy store is a regenerative fuel cell.

In one embodiment, the aircraft includes a flight control processor for controlling control surfaces of the wing assembly and tail assembly. The flight control computer takes into account the rotation of the tail assembly in determining proper control surface position. The flight control computer may also control the rotation of the tail assembly. Parameters taken into account in determining appropriate tail assembly rotation include the time of day, season of the year, geographic location, and direction of flight.

In another embodiment, the aircraft includes a fore assembly, which, like the tail assembly is rotatably coupled to the fuselage. The fore assembly includes at least two fins. Solar cells are mounted to the upper surfaces of the fins. A front drive motor rotates the tail assembly about the longitudinal axis of the aircraft to track the sun and thereby increase the fins' exposure to sunlight during flight. In such an embodiment, the flight controller controls the front drive motor and adjusts the flight control surfaces of the aircraft based on the rotational position of the front assembly.

According to another aspect, the invention relates to a method of powering an aircraft having solar cells mounted on the tail of the aircraft. The method includes determining an elevation of the sun relative to a current bearing of the aircraft. The aircraft rotates its tail assembly about a longitudinal axis of the aircraft based on the sun's elevation and a bearing of the aircraft. The rotation increases the exposure of the solar cells to the sun. In one embodiment, the method also includes rotating a fore assembly of the aircraft to increase exposure to the sun to solar cells mounted on the fore assembly. The method includes powering the aircraft using energy output by the solar cells. The control surfaces of the aircraft are adjusted to maintain the bearing.

In one embodiment, excess energy output by the solar cells is stored in an energy store. Suitable energy stores include rechargeable batteries and regenerative fuel cells. In low light conditions, the aircraft uses power stored in the energy store instead of, or as a supplement to, energy output by the solar cells.

In another embodiment, the method includes selecting a flight path to increase solar energy collection. For example, in one embodiment, the flight path is selected such that the aircraft tail assembly need only be rotated during or after significant aircraft turns to maintain or increase solar energy collection.

### BRIEF DESCRIPTION OF THE DRAWINGS

The foregoing discussion will be understood more readily from the following detailed description of the invention with reference to the following drawings:

FIGS. 1A and 1B are schematic diagrams of solar-powered aircraft, according to illustrative embodiments of the invention.

FIGS. 2A-C are schematic diagrams of illustrative tail configurations suitable for use in the solar-powered aircraft of FIGS. 1A and 1B, according to an illustrative embodiment of the invention.

FIG. 3A is a schematic diagram of a rear portion of the solar-powered aircraft of FIG. 1A or 1B, according to an illustrative embodiment of the invention.

FIG. 3B is a schematic diagram of an alternative rear portion of the solar-powered aircraft of FIG. 1A or 1B, according to an illustrative embodiment of the invention.

FIG. 4 is a schematic diagram of a second portion of the solar-powered aircraft of FIG. 1A, according to an illustrative embodiment of the invention.

FIG. 5 is a flow chart of a method of operating the solar-powered aircraft of FIG. 1A or 1B, according to an illustrative embodiment of the invention.

FIG. 6 is a diagram of a flight path optimized for the solar-powered aircraft of FIG. 1A or 1B, according to an illustrative embodiment of the invention.

FIG. 7 includes charts indicating the performance of the solar-powered aircraft of FIG. 1A or 1B in comparison to the performance of a solar-powered aircraft without rotating, sun-tracking flight surfaces, according to an illustrative embodiment of the invention.

### DETAILED DESCRIPTION OF CERTAIN ILLUSTRATIVE EMBODIMENTS

To provide an overall understanding of the invention, certain illustrative embodiments will now be described, including solar-powered aircraft and methods for their operation. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

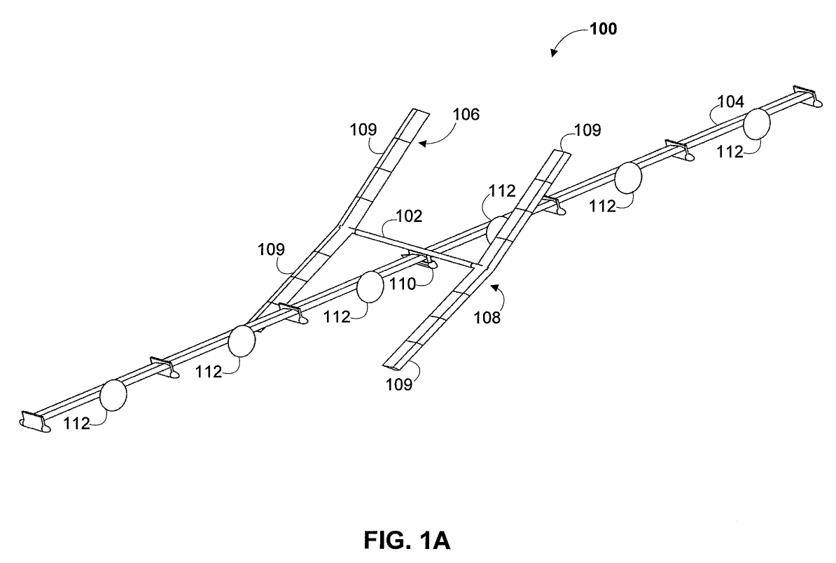

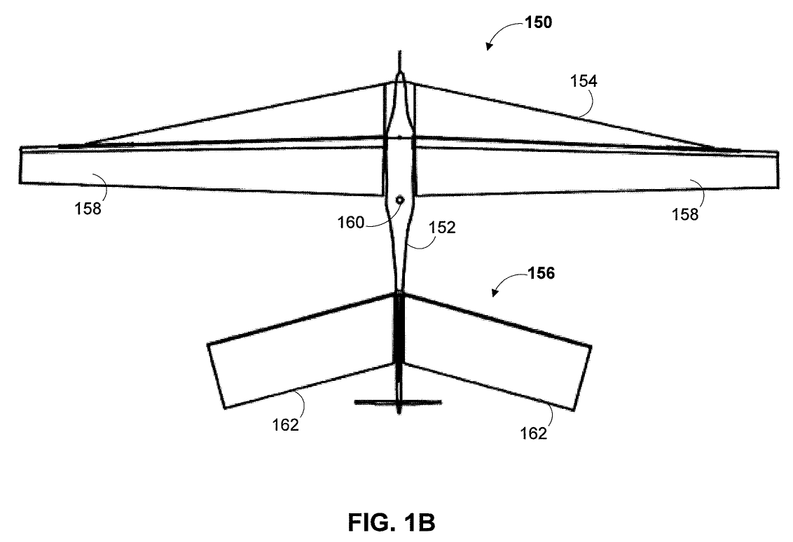

FIG. 1A is a schematic diagram of solar-powered aircraft 100, according to an illustrative embodiment of the invention. The solar-powered aircraft includes a fuselage 102, a set of wings 104, a tail assembly 106, and a fore assembly 108, and a payload compartment 110. The solar-powered aircraft is propelled by a series of electric motors 112 mounted on the wings 104.

The fuselage 102 is formed from a light weight material, such as an aluminum allow, or carbon-fiber. The tail assembly 106 and fore assembly 108 are coupled to the fuselage such that they are free to rotate about an axis defined by the fuselage. The rotation of each assembly is controlled by a solar array drive motor, such as a Type 6 Solar Array Drive, available from Moog Inc., of East Aurora, N.Y.

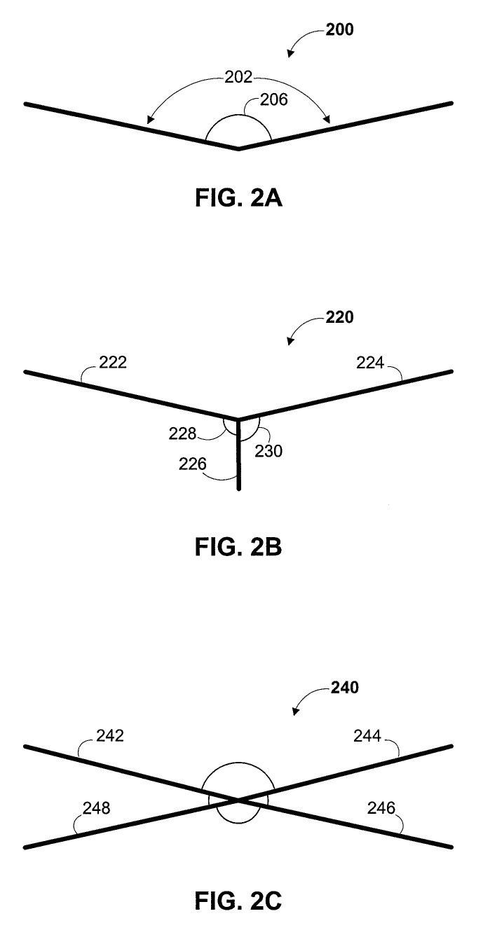

The tail assembly 106 and fore assembly 108 each include at least two fins 109. The uppermost fin surfaces carry arrays of solar cells to power the aircraft. Suitable solar cell arrays include thin film cells provided by Emcore Corporation of Albuquerque, N. Mex., or SepctroLab of Sylmar, Calif. (a Boeing company), though solar cells of other types and manufacturers may be utilized without departing from the scope of the invention. Descriptions of illustrative fin configurations suitable for the tail assembly 106 and fore assembly 108 are provided below in relation to FIGS. 2A-2C. Preferably, the fins 109 are sized, shaped, and oriented such that they generate at least enough lift to support their own weight when in the generally horizontal (or neutral) position. The fins 109 serve as or include flight control surfaces. In implementations of the aircraft that include fins 109 oriented in a V configuration and integrated control surfaces, the flight control surfaces are ruddervators, which combine the functions of a rudder and traditional elevators. In certain implementations, the solar cells are mounted on the upper surfaces of the ruddervators, as well as on the remainder of the fins 109. In other implementations, the solar cells are not mounted on the control surfaces, but are only mounted on the remainder of the fins 109. The size of the fins of the fore and tail assembly 108 and 106 are selected based on the power needs of the aircraft, including the power needs of any auxiliary equipment included for a particular mission. For example, for missions requiring power-hungry electronics, such as a radar, the fin sizes of the tail and fore assemblies 106 and 108 are selected to be larger than for missions requiring low-power equipment.

The wings 102 of the aircraft 100 support at least one pair of electric motors 112 driving corresponding propellers, to propel the aircraft. One example of a suitable motor 112 includes the PN TG8260 ring motor available from Thin Gap LLC, of Ventura, Calif. The electric motors 112 are independently controllable to provide differential thrust, providing the primary source of yaw control for the aircraft 100. The wings 102 may also support pairs of skids or landing gear pods 114 with retractable landing gear for supporting the aircraft 100 on the ground. The wings include ailerons to assist in controlling the flight of the aircraft 100.

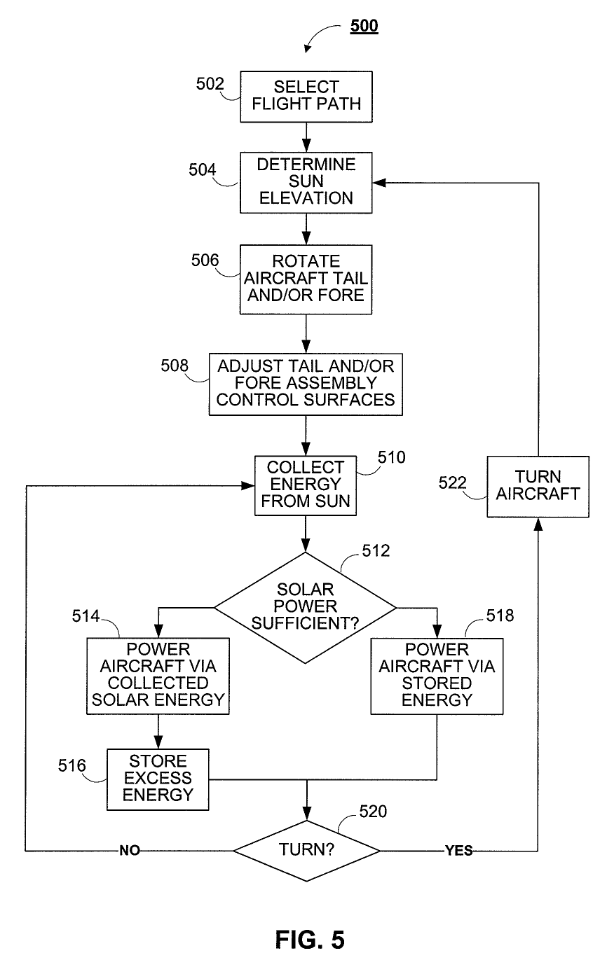

The fuselage also supports the payload compartment 110. The payload compartment 110 houses an energy store, such as a rechargeable battery or regenerative fuel cell, for storing excess electricity generated by the solar cells. The payload compartment 110 also includes a flight computer. The flight computer controls the control surfaces (i.e., the ailerons on the wings and the fins or ruddervators of the fore assembly 108 and tail assembly 106) to maintain a desired flight path. It also determines the appropriate rotation of the tail assembly 106 and fore assembly 108 to track the sun and increase solar power generation. The rotational angle is determined based on latitude of the flight path, the time of day, the season of the year, and the bearing of the aircraft. The rotational angle is also input into the flight computer so that the rotation can be compensated for by the flight control algorithm as described further in relation to FIG. 5.

In the preferred embodiment, the aircraft 100 is autonomous. In such an embodiment, the aircraft stores a flight path loaded into the flight computer memory before lift-off. Alternatively, the payload 110 houses wireless communication equipment enabling communication with a satellite or a ground-based transmitter. Such transmitters may transmit updated or entirely new flight plans to the aircraft, enabling extended air time between landings. In an alternative implementation, the transmitters enable real-time or near-real time remote control of the aircraft 100. In still other embodiments, the aircraft includes a crew compartment with control apparatus enabling piloted flight. Such embodiments require increased wingspans and fin sizes to account for the additional needed lift.

The flight computer may also control any auxiliary payload equipment, such as the communication equipment referred to above or surveillance equipment. The flight computer may or include targeting functionality if the aircraft is carrying any weaponry.

FIG. 1B is a schematic diagram of an alternative embodiment of a solar-powered aircraft 150, according to one embodiment of the invention. The aircraft 150 forgoes a fore assembly, including wings 154 and the tail assembly 156. In this embodiment, the wings 154 are mounted to fuselage 152 at or near the front end of the fuselage 152, though it could be mounted towards the middle of the fuselage without departing from the scope of the invention. In one implementation, the wings 154 are membrane wings, lacking a typical rigid airframe. Control surfaces 158 of the wings alter the shape of the membrane, thereby adjusting the lift characteristics of the wings 154. Vertical kingposts 160 extend both above and below the fuselage 152. Cables extend from the kingposts 160 to positions on the wing to provide support. The aircraft includes a single rear-mounted electric motor 162.

The tail assembly 156 of aircraft includes three fins 162, as depicted in fin configuration 220 described below. Two of the fins 162 have solar panels mounted thereon and are controllable to cancel out their lift as described further below. The tail assembly 156, like the tail assembly 106 rotates about a longitudinal axis of the aircraft 150 to track the sun.

The aircraft 150, however, may suffer from poor gust response when the tail assembly is rotated. That is, with only a tail assembly and no fore assembly, if the tail assembly 106 is rotated to track the sun and the aircraft 100 receives a lateral gust, the tail assembly 106 will move laterally causing rotation about the aircraft center of gravity. Because of the low speed flight regime necessary for solar-powered flight, this would result in a significant aircraft yaw causing one wing tip to speed up and one to slow down, possible reducing the lift at the low speed tip to zero. This tip speed differential would then induce a roll. This yaw/roll coupling is difficult to counter with either engine speed up or aileron actuation and will cause the aircraft to become unstable.

These challenges are reduced by including the fore assembly 108. In embodiments including the fore assembly 108 and the tail assembly 106, lateral gusts result in lateral movement of the entire aircraft with reduced, and in some cases, no rotation. Inclusion of the fore assembly 108 also includes more surface area for solar energy collection.

In still another embodiment, a solar-powered aircraft includes only a rotating, sun-tracking fore assembly with solar cells mounted thereon and wings, but not a sun-tracking tail assembly.

For the sake of clarity, the remainder of this specification will refer to the aircraft 100. However, the description provided below apply equally to the aircraft 150.

FIGS. 2A-2C are schematic diagrams of three illustrative fin configurations 200, 220, and 240, suitable for use in either the tail assembly 106 or fore assembly 108 of the aircraft 100. In one embodiment, the tail assembly 106 and fore assembly 108 utilize the same fin configuration 200, 220, or 240. In alternative embodiments, the tail assembly 106 has a different fin configuration than the fins of the fore assembly 108. For example, in one embodiment, the fins of the fore assembly 108 are configured according to fin configuration 200 or 240, and the fins of the tail assembly 106 are configured according to fin configuration 220.

In the fin configuration 200, depicted in FIG. 2A, the tail assembly includes two fins 202. The fins are arranged in a “V” configuration. Preferably, the angle 206 between the fins 202 is as great as possible to maximize solar energy generation, while still retaining sufficient flight stability. Thus, suitable values for the angle 206 range between about 150 degrees and about 175 degrees. In one particular implementation, the angle is 170 degrees.

FIG. 2B illustrates an alternative fin configuration 220. Fin configuration 220 includes a three fins 222, 224, and 226 in a “Y” configuration. Solar cells are mounted to the upper surfaces of fins 222 and 224. Fin 226 is oriented such that the angles 228 and 230 between fin 226 and fins 222 and 224, respectively, are equal and each greater than 90 degrees. The inclusion of the fin 226 provides added stability at the cost of increased aircraft weight.

FIG. 2C illustrates a third fin configuration 240. Fin configuration 240 includes 4 fins, arranged in an “X” configuration. In one implementation, solar cells may be mounted on both the upper surfaces of fins 242 and 244 and on the lower surfaces of fins 246 and 248. Fin configuration 240 may be particularly useful in environments requiring high degrees of fault tolerance. For example, such a configuration 240 might be desirable for planetary exploration purposes. By having two sets of solar cells, if the solar cells on the upper surfaces of the fins 242 and/or 244 fail, the entire fin assembly can be rotated such that the fins 246 and 248 serve as the upper fins.

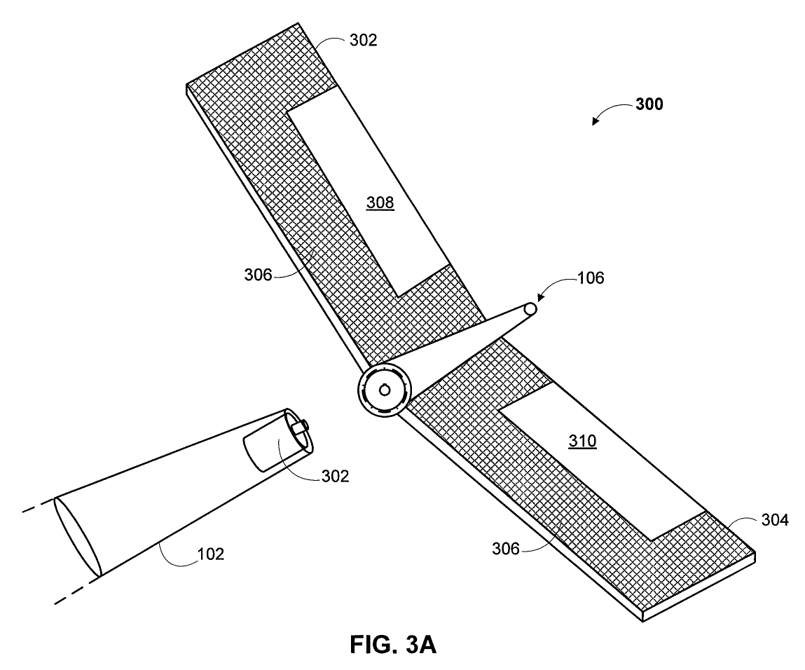

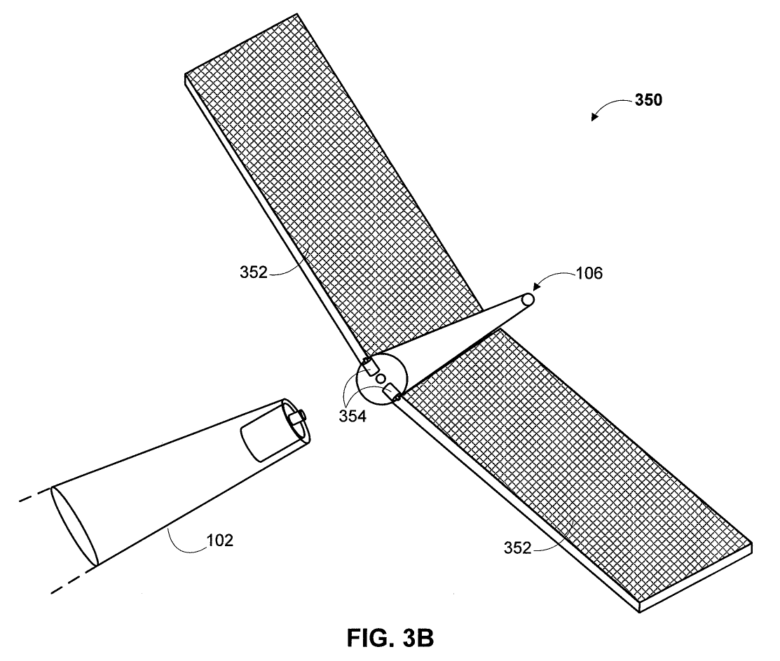

FIG. 3A is a diagram of a rear portion 300 of the aircraft 100, according to an illustrative embodiment of the invention. The rear portion includes the rear of the fuselage 102 and the tail assembly 106. A drive motor 302 is mounted in the rear-most portion of the fuselage for controlling the rotation of the tail assembly 106. The end of the drive motor 302 includes a mounting surface for securely attaching to a mating surface in the tail assembly 106.

The tail assembly 106 depicted in FIG. 3 has a fin configuration corresponding to fin configuration 200 of FIG. 2A. It includes two fins 302 and 304, each including corresponding control surfaces 308 and 310. In one embodiment, solar cell arrays 306 are mounted to virtually the entire upper surface of each fin 302 and 304. In alternative embodiments the solar cell arrays 306 are mounted only on the stationary portions of the upper surface, and are not mounted on the control surfaces 308 and 310. Preferably, the control surfaces 308 and 310 make up a relatively large portion of the fins in comparison to control surfaces utilized in tail assemblies of ordinary aircraft. The larger relative size reduces the amount of movement needed by the control surfaces 308 and 310 to effect flight control. Particularly in embodiments in which solar cells 306 are mounted on the control surfaces, reduced control surface movement is desirable to maintain a desired orientation of the solar cells relative to the sun.

FIG. 3B is a schematic of an alternative rear portion 350 of the aircraft 100, according to another illustrative embodiment of the invention. As with the rear portion 300, the rear portion 350 includes the back end of the fuselage 102 of the aircraft 100 as well as a tail assembly 106. In contrast to the rear portion 300, though, the fins 352 of the rear portion 350 lack distinct control surfaces, such as control surfaces 308 and 310. Instead, the angle of attack of the fins 352 may be adjusted using fin actuators 354. As a result, the entire surface of each fin 352 acts as a control surface. Adjusting the angle of attack of the fins by less than 1 degree can fully offset the lift of the fins 352, simplifying control of the aircraft 100 when the tail assembly 106 is rotated about the aircraft's longitudinal axis. Using the entire surface of the fins 352 of the fins also simplifies the installation of solar cells across the entire upper surface of the fins 352.

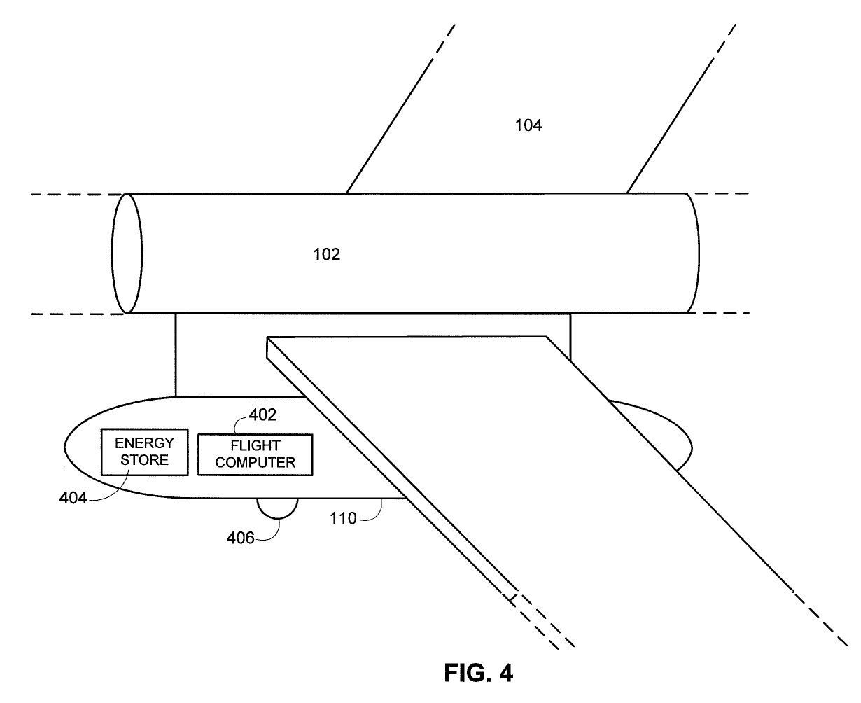

FIG. 4 is a diagram of a central portion 400 of the aircraft 100, according to an illustrative embodiment of the invention. Wings 104 and a payload compartment 110 are suspended below the fuselage 102 between the tail and fore assemblies 106 and 108. The wings 104 are preferably suspended from about the middle of the length of the fuselage 102. The wings 104 include trailing edge ailerons for primary pitch and roll control.

The payload compartment 110 houses a flight computer 402 and an energy store 404. In one embodiment, the flight computer 402 is a special purpose computer specifically designed for aircraft control and management. In alternative embodiment, the flight computer 402 is a general purpose computer. In either case, the flight computer 402 may include a computer readable medium, such as a magnetic, optical, magneto-optical, or holographic disk drive and/or integrated circuit memory, storing computer readable instructions. The flight computer 402 includes a processor for executing such instructions, thereby causing the flight computer 402 to carry out the functionality described herein. Alternatively, some or all of the functionality may be implemented via application specific integrated circuits included in the flight computer 402.

The flight computer 402 controls substantially all aircraft activity, including flight control, navigation, communications, solar tracking, rotation of the tail and fore assemblies 106 and 108, energy management, and control of any auxiliary payload equipment. For example, in one embodiment, the cargo payload 110 houses surveillance equipment 406 to support intelligence, military, or exploratory missions. Alternatively, the cargo payload 110 may include enhanced communication equipment to provide a communication link to reserves operating on the ground. The communication equipment may include one or more radio frequency antennas and transceivers for receiving ground communications, as well as an antenna and transceiver configured for communication with orbiting satellites or other aircraft in the vicinity. In still another embodiment, the cargo payload 110 may include munitions, such as precision guided bombs for conducting remote warfare. Alternatively, munitions may be mounted to the wings 204. In still other embodiments, the cargo payload 110 includes a combination of the above systems.

In alternative embodiments, instead of the flight computer 402 managing substantially all functionality of the aircraft 100, the cargo payload includes several networked computers and/or special purpose processors for controlling respective aircraft and payload systems.

The energy store 404 stores excess energy generated by the solar cells for use when the solar cells are unable to generate sufficient energy on their own, for example at night, or when the sun is temporarily occluded by a cloud. In one embodiment, the energy store 404 is a rechargeable battery. In another embodiment, the energy store 404 is a regenerative fuel cell. The regenerative fuel cell may include water and hydrogen stores, as well as a hydrolizer for hydrolyzing stored water and storing the resulting hydrogen.

In alternative embodiments, aircraft 100 may forgo a separate cargo payload 110 and instead house the flight computer 402 and energy store 404 within the fuselage 102, itself.

FIG. 5 is a flow chart of a method 500 of operating the solar-powered aircraft 100 of FIG. 1, according to an illustrative embodiment of the invention. The method begins with the aircraft selecting a flight path (step 502). In one embodiment, the flight path is selected to limit the turning of the aircraft, favoring flight paths with relatively long periods of relatively straight flight. Doing so reduces the need to rotate the tail and fore assemblies 106 and 108 other than during significant turns. Reducing the frequency with which the tail and fore assemblies 106 and 108 need to rotate reduces the energy consumption of the aircraft and simplifies the flight control process. That is, the position of the control surfaces of the tail and fore assemblies 106 and 108 only need to be adjusted while the assemblies 106 and 108 are being rotated.

The flight path is also selected (step 502) such that the relatively straight legs of the flight path enable the solar cells, when the tail and fore assemblies 106 and 108 are properly rotated, to be substantially normal to direct sunlight. Thus, the specific direction of any relatively straight leg will vary based on the season of the year, the latitude at which the flight is occurring and the time of the day. In one embodiment, the flight paths are selected to track the sun in azimuth.

Finally, the flight path, as selected, must meet the criteria of the given flight's mission. For example, for missions providing communication support to ground resources at a relatively fixed location or surveillance of a fixed target, the flight path should be selected to limit the amount of time the aircraft 100 is outside of the communication range of the ground resources or surveillance range of the target.

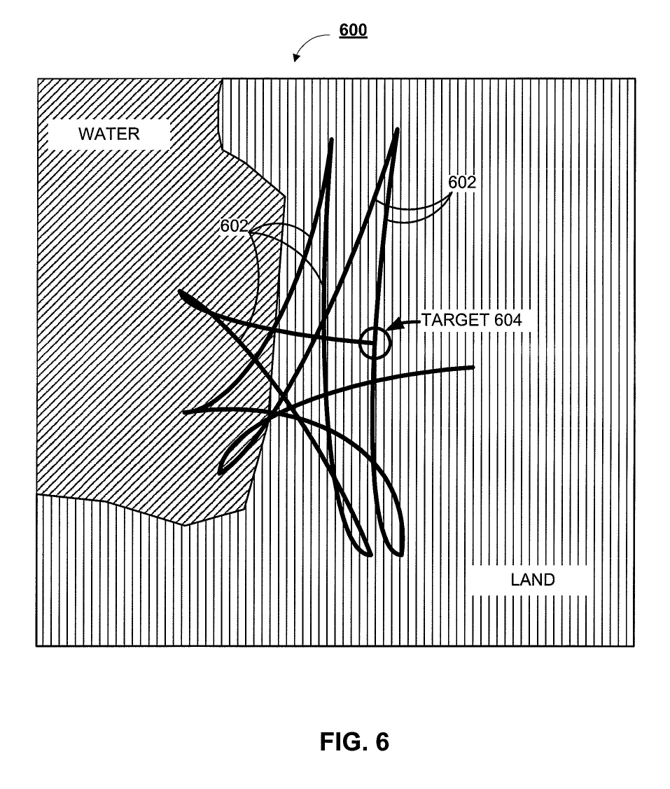

FIG. 6 is an illustrative example of a suitable flight path 600 for a surveillance mission. The flight path includes eight relatively straight legs 602 near a target 604. While some of the legs 602 include some degree of arc, changes in direction are predominantly effected in major turns at the end of the legs 602. This would be in contrast to a generally circular flight path about a target. Such flight paths are also acceptable, but require more frequently tail and fore assembly 106 and 108 rotation, further control surface adjustments, and thus increased power consumption. Such adjustments also increase the opportunity for component failure and increase the ware on the components.

Referring back to FIG. 5, after the flight plan is selected (step 502), the elevation of the sun is identified for a current leg of the flight path (step 504). Sun elevation may be determined by retrieving data from stored solar position data tables or from mission specific data. The aircraft 100 then rotates the tail and fore assemblies 106 and 108 (step 506) such that incident sunlight is substantially normal to the solar cells mounted on the tail and fore assemblies 106 and 108. For long legs during which the position of the sun would move substantially during the leg, or for legs including some arc or change in bearing, the flight computer 402 selects an assembly rotation, for example, that maximizes exposure to sun for the planned flight leg. The flight computer 402 then adjusts the control surfaces of the tail and fore assemblies 106 and 108 such that the fins 109 of the assemblies 106 and 108 provide substantially zero lift (step 508). In this state, the tail and fore assemblies 106 and 108 induce limited to zero pitch, yaw, or roll on the aircraft, regardless of the angle of rotation of the assemblies 106 and 108. In one embodiment, the flight computer 402 adjusts the control surfaces of the fins 109 (step 508) continuously as the assemblies are rotated (step 506). Alternatively, the rotation (step 506) and control surface adjustment (step 508) is carried out in a step wise fashion, wherein the desired rotation is affected in discrete steps, with the flight computer 402 affecting a flight control surface adjustment simultaneously with, or between each, discrete rotation step.

After the control surfaces of the fins 109 are properly adjusted, the aircraft flies along the flight path, collecting energy from the sun via the arrays of solar cells (step 510). In one embodiment, any minor maneuvers necessary to maintain the selected flight path are affected by adjusting the wing control surfaces (e.g., trailing edge ailerons) and through differential motor control.

In an alternative embodiment, flight control is also affected by adjusting the fin angle of attack or the position of fin control surfaces from their respective zero-lift positions. As the tail assembly rotates about the linear axis of the fuselage, the affect of any fin movement changes based on the cosine of the angle of rotation. That is, if a fin deflection adjustment (ΔFD) from the fin zero-lift position (FD₀) would result in a particular combination of aircraft pitch (P₀) and yaw (Y₀) in the neutral tail assembly position R₀ (i.e., 0 degrees rotation), the pitch and yaw imparted by the same ΔFD at assembly rotation angle (R₁) is determined according to the following equations:

P₁=P₀*(cos(R₁))

Y₁=Y₀*(1−cos(R₁))

To account for the varying pitch and yaw effects of a rotated tail or fore assembly 106 and 108 on flight control, the drive motors provide the assemblies' current rotation position to the flight computer 402 so that the flight computer can compensate for the variation. Due to the large size of the fins, a full range of aircraft angles of attack needed to affect the desired aircraft maneuvers can be achieved with fin deflections of less than 1 degree, regardless of the rotation of the fore and tail assemblies.

While flying in a given leg of the flight path, the flight computer 402 analyzes the power output of the solar cells to determine whether the solar cells are outputting sufficient power to meet the aircraft's power needs (decision block 512). If the power output of the solar cells is sufficient, the aircraft utilizes the collected solar power to operate (step 514) and stores any excess energy in the energy store 404 (step 516).

If the output of the solar cells is insufficient (decision block 512), the flight computer 402 determines whether the power differential is sufficient to justify ceasing solar power collection altogether, e.g., late in the evening, or under heavy cloud cover. If the power output is too low to justify the decrease in lift associated with the rotation of the assemblies 106 and 108, the flight computer 402 drives the drive motors to rotate the assemblies 106 and 108 into their neutral, maximum lift providing position. The aircraft 100 is then run entirely off of energy stored in the energy store 404 (step 518). If the power output is insufficient to fully power the aircraft 100, but enough to make a substantial contribution thereto, the flight computer 402 maintains the assembly 106 and 108 rotation and makes up the power differential from the energy stored in the energy store 404 (step 518).

The aircraft 100 continues along its flight path (step 514 or 518) until the flight path includes a substantial turn, e.g., at the end of a flight leg (decision block 520), occasionally, continuously, or periodically verifying whether additional power needs to be extracted from the energy store to maintain aircraft operation (decision block 512). If the aircraft needs to make a significant turn (decision block 520), the flight computer 402 adjusts the position of the control surfaces of the wings 104 and/or the tail and fore assemblies 106 and 108, and adjusts the power applied to each of the motors to effect the turn (step 522). As the aircraft 100 exits the turn, the flight computer determines a new relative sun position (step 504) and adjusts the rotation (step 506) and control surfaces of the tail and fore assemblies (step 508) as necessary to continue its mission.

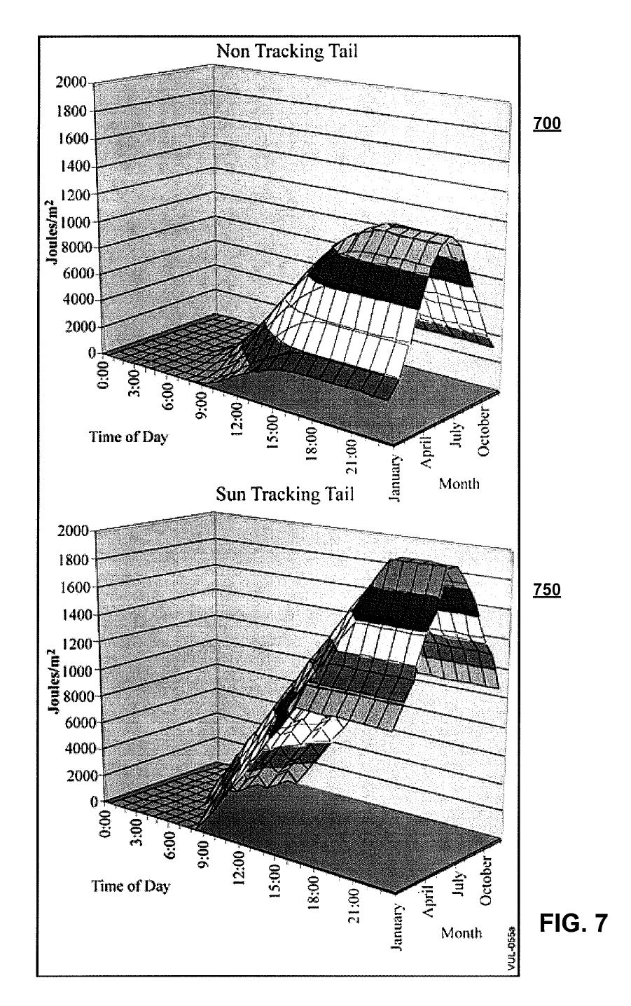

FIG. 7 includes two charts, chart 700 and chart 750 which demonstrate the efficiency gains provided by using a rotating solar array that can track the sun in comparison to an aircraft having a fixed solar array. Chart 700 depicts the cumulative energy generated per square meter of a solar array mounted on the upper surface of the wing of an aircraft by time of day and month of the year. Energy generation is generally negligible in the morning and in the evenings. Energy collection rates increase as the sun rises, and then decline as the sun sinks in the sky. At these times, portions of the solar array receive no sunlight, receive reduced sunlight, or receive sunlight at an angle which is less efficient at generating solar power. In the winter months, in particular, as days are shorter, and the sun does not rise as high in the sky, the inability to track the sun's progression through the sky dramatically limits the ability to generate solar power.

Chart 750, in contrast, depicts the cumulative energy generated per square meter of a solar array mounted on a tail assembly which can be rotated to track the position of the sun in the sky, such as is employed in the aircraft 100. As depicted in chart 750, energy generation is substantially constant from sunrise to sunset. Moreover, the constant rate is equal to, and in some cases, is even greater than the maximum energy generation rate of the fixed solar array. In the winter months, total daily energy generation from a sun tracking solar array may exceed 350% of that generated by wing mounted non-tracking solar arrays.

The invention may be embodied in other specific forms without departing from the spirit or essential characteristics thereof. The forgoing embodiments are therefore to be considered in all respects illustrative, rather than limiting of the invention.

1. An aircraft comprising:
a fuselage having a front and a rear and defining longitudinal axis of the aircraft;
a wing assembly coupled to fuselage including wing flight control surfaces;
at least one electric motor for powering the aircraft;
a tail assembly, rotatably coupled to the fuselage at about the rear of the fuselage, the tail assembly including:
at least two tail fins; and
a plurality of solar cells mounted on an upper surface of the at least two tail fins for powering the at least one electric motor;
a rear solar drive motor for rotating the tail assembly about the longitudinal axis during flight based on the position of the sun relative to the aircraft to increase exposure of the solar cells to sunlight.

2. The aircraft of claim 1, comprising a energy store electrically coupled to the solar cells and the at least one electric motor.

3. The aircraft of claim 2, wherein the energy store comprises a battery.

4. The aircraft of claim 2, wherein the energy store comprises a regenerative fuel cell.

5. The aircraft of claim 1, wherein the tail assembly includes two fins arranged in a V orientation.

6. The aircraft of claim 1, comprising a flight control processor for controlling control surfaces of the wing assembly and the tail assembly, wherein the flight control processor takes into account rotation of the tail assembly about the longitudinal axis in controlling the control surfaces.

7. The aircraft of claim 6, wherein the flight control processor controls the rear solar drive motor based on a time of day, a season of the year, a geographic location, and a direction of flight.

8. The aircraft of claim 1, wherein the tail assembly includes a third fin, wherein the angles between each of the at least two fins having solar cells mounted thereon and the third fin is equal and greater than 90 degrees.

9. The aircraft of claim 1, comprising:
a fore assembly, rotatably coupled to about the front of the fuselage, including:
at least two fins;
a plurality of solar cells mounted on upper surfaces of the fins; and
a front solar drive motor for rotating the fore assembly about the longitudinal axis during flight based on the position of the sun relative to the aircraft to increase exposure of the solar cells mounted on the fore assembly to sunlight.

10. The aircraft of claim 9, comprising a flight control processor for controlling control surfaces of the wing assembly, the tail assembly, and the fore assembly, wherein the flight control processor takes into account rotation of the tail assembly and the fore assembly about the longitudinal axis in controlling the control surfaces.

11. A method of powering an aircraft having solar cells mounted on tail of the aircraft, comprising:
determining an elevation of the sun relative to a current bearing of the aircraft;
rotating the aircraft tail about a longitudinal axis of the aircraft based on the determined elevation of the sun and a bearing of the aircraft to increase exposure of the solar cells to the sun;
powering the aircraft using solar energy output by the solar cells; and
controlling flight surfaces of the aircraft based on the rotation of the aircraft tail to maintain the bearing.

12. The method of claim 11, comprising storing solar energy output by the solar cells in a energy store.

13. The method of claim 12, wherein the energy store comprises a battery.

14. The method of claim 12, wherein the energy store comprises a regenerative fuel cell.

15. The method of claim 12, comprising powering the aircraft in low-light conditions using energy stored in the energy store.

16. The method of claim 11, comprising rotating a fore assembly of the aircraft, having solar cells mounted thereon about the longitudinal axis of the aircraft to increase exposure of the solar cells to the sun.

17. The method of claim 16, wherein the flight surfaces of the aircraft are further controlled based on the rotation of the fore assembly.

18. The method of claim 11, comprising selecting a flight path to increase solar energy collection.

19. The method of claim 11, comprising selecting a flight path such that the aircraft tail need only be rotated during significant aircraft turns while still increasing solar energy collection.

20. The method of claim 11, wherein the elevation of the sun is determined based on a time of day, a season of the year, and a geographic location.
